(19) United States
(12) Patent Application Publication
(10) Pub. No.: US 2015/0248850 A1
(43) Pub. Date: Sep. 3, 2015

(54) ARTICLES FOR SELECTING COLORS FOR SURFACES

(71) Applicant: PPG Architectural Finishes, Inc., Pittsburgh, PA (US)

(72) Inventors: Marilyn Malone, Sheffield Lake, OH (US); Barbara Richardson, Fairview Park, OH (US); Melinda Gray, Lorain, OH (US)

(21) Appl. No.: 14/658,832

(22) Filed: Mar. 16, 2015

Related U.S. Application Data
(63) Continuation of application No. 11/695,598, filed on Apr. 2, 2007, now abandoned.
(60) Provisional application No. 60/787,834, filed on Mar. 31, 2006.

(51) Int. Cl. G09F 5/04; B32B 7/06; B32B 7/12; B32B 37/00; B32B 37/26

(52) U.S. Cl. CPC G09F 5/04; G09F 5/042; B32B 37/0076; B32B 37/26; B32B 7/12; B32B 7/06; B32B 2037/268; B32B 2307/402

(57) ABSTRACT

At least one color selection article is provided having a plurality of color display sheets comprising at least one repositionable color ply over at least one backing ply and optionally at least one attachment member to attach the color display sheets together. Optionally a plurality of attached color display sheets are arranged for viewing from at least one perspective of individual or combinations of a portion of each color layer of each ply. The repositionable color ply comprises two opposing surfaces one with a color layer and the other comprising temporarily adhering pressure sensitive adhesive material for repositioning the color ply. The backing ply has a release material for releasable association with the adhesive material. A plurality of articles in a kit each have repositionable color plies to give a plurality of neutral colors and a plurality of coordinating colors to give pre-selected color schemes.

### CROSS-REFERENCE TO RELATED APPLICATION

This application in a Continuation of U.S. patent application Ser. No. 11/695,598, filed Apr. 2, 2007, entitled “Articles for Selecting Colors for Surfaces”, which claims the benefit of U.S. Provisional Patent Application Ser. No. 60/787,834, filed Mar. 31, 2006, entitled “Articles For Selecting Colors For Surfaces,” both of which are hereby incorporated by reference.

### FIELD OF THE DISCLOSURE

The present disclosure relates to novel articles to provide selection of colors from coatings, coverings and treatments like fabrics for surfaces and/or substrates of residences and/or commercial establishments and/or structures for habitation of any kind.

The present disclosure also relates to novel color display devices for the selection or choice of a more than one color from one or more collections of coordinated colors for various surfaces for furnishing buildings and/or living structures.

The present disclosure further relates to color display products for selection of one or more colors from a coordinated color collection for coatings, coverings, treatments and fabrics for use on surfaces and/or substrates of structures such as coatings or paint on walls.

The present disclosure additionally can relate to guides for the selection and identification of color of coatings like paint, stain, or varnish, coverings, fabrics, or treatments for use in decorating of solid surfaces and/or substrates on, within, and around structures, homes, houses and building.

The present disclosure also relates to color selection and identification guides for use in connection with the retail sale of tinted architectural coatings, or paints, and for use by interior decorators, designers, and architects.

### INTRODUCTION TO THE DISCLOSURE

In selecting colors for surfaces, color designers or decorators consider the relationship of various aspects of color and colors to provide recommendations for colors on various surfaces within a space of a building or dwelling. For instance for interior walls and floors in rooms of a building or for exterior walls of a building, coverings and/or coatings such as facades, trim materials, fabrics, carpets, wall coverings, accent pieces, paints, varnishes, stains, films and the like can have various colors or attributes of color from one surface to another. Additionally, architects consider colors for the exterior surfaces of residential and commercial structures to provide a particular look for the structure. For the exterior of a structure, the architect may consider the color of the outer facade for given types of construction materials such as metal, stone, glass and various trim elements. For residential homes, similar materials can be colored differently to provide a particular look for the exterior of the structure.

To assist designers, architects, decorators, and do-it-yourself home and apartment decorators and painters, supplying companies of materials and coatings have endeavored to supply a multitude of colors from one end, e.g. red, of the visible spectrum to the other end e.g. violet. Traditionally, the coatings companies supply samples of these colors on color chips or color cards and have various displays of all of the color card offerings usually in a vicinity close to the selection of the coatings such as paint. Recently, the selection of colors for coatings has also become available on computer by medium supplied by the coatings companies or third parties with mediums such as compact discs, CDs, digital video disks (DVD), jump drives, and more recently web pages on the internet and the like. A disadvantage of the computer selection of the color is that it depends on the display of color at the user's terminal as opposed to a color of the actual physical chip or color card. Providing the myriad displays of color cards can be an expensive undertaking for the supplying entity to maintain a constant supply of all of the color cards for the users. Also, coatings companies have put together assortments of colors in brochures where the colors are displayed as 2 by 3 inch or smaller color chips. These color collections are traditionally arranged around some common feature of color to present numerous colors or shades of color. For instance, such collections can include a key color along with an accent color at a minimum and possibly auxiliary colors such as that depicted in U.S. Patent Publication 20040004719 (Takada et al entitled “Color Card, Color Book Comprising the Same and Color Card with Picture Sample). In this publication there is disclosed two systems of color card displays. One system involves a plurality of color cards, each color card having a basic color along with one or more auxiliary colors and emphatic colors. The other system provides a deep color, one or more neutral colors and or one or more light colors. The publication discloses in the various systems one of the colors displayed on the color card in a larger display area than the other colors. For instance, in one system the light color is displayed in a larger area compared to the deep and neutral colors. In the other system, the basic color is depicted in a wider area than the auxiliary and emphatic colors.

Another system of color cards is disclosed in U.S. Pat. No. 6,270,123(b)(1) to Spangler, and assigned to Creanova Inc. where the color card is a horizontal arrangement of various colors based on the particular base paint that is used for or in obtaining the final color. The base paints include the pastel base, the deep base, the tint base and the accent base. This is an elaborate display of color cards, which in the stationery display provides samples of voluminous color cards. Also, the display can exist as a fan deck having the horizontal display of colors arranged in a stack, one on top of the other with a pivot at one end so that each color card swivels 360° or less to show the underlying color cards.

The myriad displays of all of the color cards ranging from one end of the spectrum, red, to the other end, violet, does not necessarily assist the user in coordinating or designing colors for a particular use. Particularly a user lacking confidence in designing or coordinating colors for more than one different surface to be covered may need additional assistance. The available collections of colors such as those available as Peel & Stick color sample brochures based on technology disclosed in U.S. Pat. Nos. 6,416,612B1, 4,457,718, U.S. Patent Application Publication 2003/0072907A1 to Lerner et al, Color Communications, Inc. provide the arrangement of colors in collections such as that available in the Color Futures brochure available from The Glidden Company, copyright 2003. These types of collections assist the user in selecting colors for the surfaces of a room or building and the objects that are present in that room or on that building structure. Such collections with their 38 samples of 17/8 inch by 21/4 inch Peel & Stick samples assist the user in selecting a key color and accent colors for a space whether it be a room inside a structure or the exterior of the structure itself. Also, the small colored Peel & Stick samples can be removed from the brochure temporarily stuck on the surface and even carried to stores to assist in acquiring objects of color for placement in the space being decorated or coordinated. To select a key color and accent colors the small Peel & Stick samples are useful where such color selection is for a smaller color space such as an interior room of a structure. To decorate a larger space with various colors such as adjoining interior rooms of a building or two or more rooms off of a common hallway inside a building or even the various outside surfaces of the exterior building, the size of the smaller color samples limits their usefulness. They are more difficult to see from a distance for a large space and from one surface to another. Of course the samples smaller size is ideal for providing the samples in a brochure style pamphlet that opens 180 degrees to have at least two flat adjoining pages. Also the smaller size of these repositionable color samples assist in having a weight and surface area that can be temporarily adhered to a surface. For decorating or selecting colors for a larger space, more pre-selected or pre-coordinated colors would benefit the user's creative input into decorating the space.

### SUMMARY

In one aspect the disclosure provides a plurality of color selection articles where each article comprises: a plurality of color display sheets comprising at least one repositionable color ply over at least one backing ply and optionally at least one attachment member to attach the color display sheets together. The color display sheets optionally are attached together by the attachment member so that each sheet is accessible at least to a degree so that the color layers of the color plies can be viewed individually or in some combination from at least one perspective. The repositionable color ply comprises two opposing surfaces one of which comprises a color layer and the other comprises at least one pressure sensitive adhesive material. The adhesive material is one capable of removably adhering the color ply to a vertical surface such as a wall for at least a time sufficient to allow visible viewing of the adhered color without the need physically to hold the color ply to the surface. Generally the time period for removability or repositionability with only limited if any marring of the surface to which the color ply was adhered is a temporary time. This time can range from any time greater than a second up to a year or more. The repositionable color ply can be repositioned from 2 to 30 times or more, and is repositionable without deleteriously marring the surface to which it was adhered. The backing ply comprises at least two surfaces where at least a portion of the surface capable of facing the adhesive material of the color layer has release material for contact with the adhesive material. The colors of the repositionable color plies for the article provide for a plurality of neutral colors and a plurality of coordinating colors that can coordinate in a manner such as an analogous color scheme, complementary color scheme or split-complementary color scheme or temperature color scheme.

In other aspects of the present disclosure the color selection articles of the collection optionally can include one or more of: an indicia for the name for each color of the article; an indicia of a discount for the purchase of one or more articles having a selected color from the color selection article; a plastic wrapper for the article; hanging display member selected from hooks, apertures in one or more extended backing plies to hold the article on a display rack at a retail location. In other aspects of the present disclosure the number of color layers on the color ply can range from 1 to 4 and the dimensions of the color layer can range from an area of 5 to 35 square inches which can be printed as a color or an ink onto the ply.

Aside from the structural and procedural arrangements set forth above, the invention could include a number of other arrangements, such as those explained hereinafter. It is to be understood, that both the foregoing description and the following description are exemplary.

Although the present disclosure may fulfill one or more of the above-mentioned needs or benefits, it should be understood that some aspects of the invention might not necessarily obviate one or more of those needs. In the foregoing summary and the following description, certain aspects and embodiments will become evident. It should be understood that the invention, in its broadest sense could be practiced without having one or more features of these aspects and embodiments. It should be understood that these aspects and embodiments are merely exemplary.

### BRIEF DESCRIPTION OF THE DRAWINGS

The accompanying drawings are incorporated in and constitute a part of this specification. The drawings illustrate exemplary embodiments of the invention and, together with the description, serve to explain some of the principles of the invention. In the below-listed drawings similar features of the disclosure have the same reference numbers:

FIG. 1 is a plan view of the front of an embodiment of a color selection article of the present disclosure.

FIG. 2 is a side view of a fanned color selection article of the present disclosure.

FIG. 3 is a front plan view of topmost color display sheet of an article of the present disclosure.

FIG. 4 is a front plan view of color display sheet under the topmost color display sheet of an article of the present disclosure.

FIG. 5 is a front plan view of the color display sheet under the color display sheet of FIG. 4.

FIG. 6 is a cross-sectional view of a color display sheet of the color selection article of the present disclosure.

FIG. 7 shows a plan view of the kit of the present disclosure having a plurality of color selection articles.

### DETAILED DESCRIPTION OF THE EMBODIMENTS

As used herein for the disclosure of the invention and for the claims to assist in facilitation of understanding the invention but not to limit the invention to operative embodiments from broader interpretations of these expressions known to those skilled in the art for technical expressions and known generally for general expressions, the expressions below can have the following exemplary but non-limiting meanings.

As used herein, spatial or directional terms, such as “left”, “right”, “inner”, “outer”, “above”, “below”, “top”, “bottom”, and the like, are understood to encompass various alternative orientations and, accordingly, such terms are not to be considered as limiting.

Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1.0 to 4.3, 5.6 to 8.7, and 7.3 to 10.0.

As used herein, the terms “on”, “applied on/off”, “formed on/over”, “deposited on/over”, “overlay” and “provided on/over” mean formed, deposited, or provided on but not necessarily in contact with the surface. For example, a layer “formed over” a substrate does not preclude the presence of one or more other layers of the same or different composition located between the formed layer and the substrate.

The expression “pressure sensitive repositionable adhesive” means an adhesive material or composition which releasably binds an object to a substrate base preferably for a temporary period of time sufficient to allow viewing by a person of the adhered object to a vertical surface from a distance of around at least 4 feet. A pressure sensitive adhesive can be applied to a base or backing to which the object is mounted and when the object is removed from the base, the pressure sensitive adhesive will transfer to or move to the object and the object will retain the adhesive which will permit the object to be adhesively mounted to another base for a temporary period of time. A suitable pressure sensitive adhesive is one that is capable of being printed. Suitable pressure sensitive adhesives include but are not limited to acrylic emulsion polymers which are commercially available as Aroset 2538 and 2539 from Ashland Chemical Company, and microsphere acrylic polymers which are commercially available as 271 Series Adhesive Gel-Tac Acrylic Polymers from Advanced Polymers International. The repositionable pressure sensitive adhesive is an adhesive which removably affixes an object onto a base or substrate on a base, but does not transfer to the object being removed from the substrate. This adhesive can be applied directly to the color layer which then is bonded to the release composition. This adhesive may be applied by roil coating or any known method. Another suitable adhesive includes but is not limited to an acrylic polymer microsphere commercially available as Gel-Tac 101 Series and Gel-Tac 102 series from Advanced Polymers International.

“Release material” means a composition which is coated onto a release liner or on an object to be adhesively affixed to repositionable pressure sensitive adhesive (“RPSA”) to facilitate the removal of the object which is adhesively affixed to a base with the RPSA. Suitable release materials include compositions such as but not limited to a wax and varnish blend which is suitable to release an object affixed with Aroset adhesives; a free radical UV silicone release composition commercially available from Croda Adhesives, Inc., as Croda 30-19-3; a cationic UV silicone release composition commercially available from Croda Adhesives as Croda 30-24-1; a two component thermoset release composition commercially available as Croda 2426-2 parts 1 and 2; and conventional commercially available silicone release compositions. The Croda and conventional silicone release compositions are suitable for use with the Aroset indirect adhesive and the 271 indirect adhesives from Advanced Polymers International. The release material can also be a liner such as a paper or polymeric film which may be coated with a release composition to facilitate the removal of an object from the release liner and movement of an indirect adhesive to the object or retention of a direct adhesive on an object, such that the object may be removably adhesively affixed to a substrate other than the release liner. For instance at least one release material can be applied as a coating over one side or a portion of one side of a liner as a liquid silicone. The silicone can be cured thermally or by exposure to ultraviolet (“UV”) radiation.

The terms “ply” and “layer” are used at least to aid in the understanding of at least the preferred embodiment of the present disclosure such as a ply can have one or more layers. Of course these terms are general terms such that one skilled in the art could also have an arrangement where a layer has one or more plies.

“Repositionable” refers to the temporary nature of the adherence of the color layer to a surface by the repositionable adhesive which is such that the color ply can be removed by peeling from the surface to which it is adhered without damaging the underlying surface or leaving major amount of tackiness to the touch when removed. Of course left on too long could leave marks or tackiness or not be peeled off in one piece or remove some underlying surface. Of course if the color ply is left on a surface for a period of time of a couple of days in direct sunlight at a temperature of around 90 degrees or more it may not be repositionable without some affect to the underlying surface. Repositionable means the color layer releasably bonds with a surface by a temporary adhesive providing a bond strength of 0.8 to 3 oz/inch using a 180 degree peel adhesion test after about 24 hour swell time and minimum 250 grams wet tack bond strength contact placement within 30 seconds or less. The term “repositionable” means an adhesive or pressure sensitive adhesive surface can be applied and adhered to a substrate and then removed (generally within 24 hours) and reapplied without distorting, defacing or destroying the backing, adhesive, or substrate; repositionable adhesives need not be positionable or vice versa;

The terms “releasable adherence” as used throughout this application including the claims means that the color layer is adhered to another surface but is capable of being separated from that surface during normal use, such as a user separating the color layer from a wall by hand, so that the color layer with the adhesive layer remains intact and may be applied to another surface. Suitably, no complicated mechanical apparatus or chemicals are needed to releasably separate the two items. The releasable adherence of the color layer from the backing ply of the color display sheet is facilitated by the release material associated with the backing ply.

The term “adhesive” refers to the adhesive composition, and may also refer to the adhesive layer of an adhesive article.

The term “positionable” means an adhesive or pressure sensitive adhesive surface can be placed against a substrate surface and easily slid over the surface into proper position without pre-adhering to the substrate; pressure is generally required to adhere the adhesive article to the substrate.

“removable” means an adhesive or pressure sensitive adhesive surface can be adhered to a substrate surface and the adhesive and backing can be simultaneously removed from a substrate without ply failure, “two-bond” failure, adhesive transfer, or backing disintegration.

“sheet” means thin, large surface area articles which can be rectangular shapes or in other configurations that can be individually repositionable or, when releasably supported by a backing or carrier in a desired pattern, collectively repositionable.

“tack” means instant contact adhesion between the adhesive and the substrate, and the tack may be substrate specific.

Further as used herein the term “Neutral” in reference to color in its narrowest aspects refers to traditional neutral colors of black, white and combined shades of these two some which result in gray shades. Generally these colors are not found on a color wheel as is known to those skilled in the art since they are essentially combinations of many colors of the spectrum and sometimes referred to as non-colors. Generally the true neutral colors of the narrowest meaning of the term go with any color without clashing including the color black. The broader meaning of the term Neutral in reference to color is a color which is sufficiently low in chromaticity that the hue of that color is not readily discernable by a typical observer. The broadest meaning of the term neutral in reference to color is all of the foregoing meanings an including the very low intensity colors of one of the three primary colors that are the most muted versions of that color on the color wheel. These include: i) the red-toned neutrals from a hint of beige to deep, russet browns; ii) Yellow-toned neutrals ranging from subtle creams to deep golden browns; and iii) blue-toned neutrals from a whisp of gray to charcoals to deep blue-blacks. Preferably the very low intensity neutral colors schemes of do not mix the different tones. Another way at looking at what comprises neutral colors is that these are colors that appear warm when compared to a cool color and cool when compared to a warm color. Warm colors as the terms imply are generally associated with fire and sunlight such as pinks and yellows whereas cool colors are associated with the sky and water such as pale or light blues and green. Generally the neutral colors have chroma values of less than 250 and more preferably less than 200.

The foregoing terms dealing with color can be better understood in the context of a system or model that describes color. Generally the coordination of colors can be based two basic approaches, which are additive color mixing and subtractive color mixing. Additive color mixing is used in light. The three light primaries—Red, Blue and Green,—when combined (added) will produce white light. The three secondary colors are produced when two of the primaries are mixed such as:

### Red+Blue=Magenta;

### Blue+Green=Cyan; and

### Red+Green=Yellow.

Subtractive color mixing is used generally with coatings such as paint. The three paint primaries—magenta, cyan and yellow,—when mixed together will produce black. Subtractive color mixing is also used to produce colored light—White light, when passed through a red color media (which subtracts the blue and green hues) to produce red light.

Standardized systems or models to describe colors are well known to those skilled in the art in the form of two dimensional color wheels or circles to the more complex three dimensional color systems like the Munsell or CEI color systems.

The Munsell system which is generally applicable to subtractive color mixing identifies color in terms of three characteristics, hue, value and chroma, which are arranged in the Munsell chart into orderly scales of equal visual steps. The Munsell color system provides numerical scales for these attributes which are given symbols, and colors are expressed with these symbols and numerals. Such notation of colors enables the selection of a specific color to a certain degree of accuracy by the symbol and numeral. Hue is the attribute of color which is commonly described by words such as “red,” “yellow,” “green,” “blue,” “purple,” and the like. Value is the attribute of color which is described by the words “light,” “dark,” and the like. Chroma is the attribute of color which is described by the words “bright,” “dull,” and the like. Munsell color space is a three-dimensional space including and describing visual relationships between colors. This color space is based on a collection of actual physical samples arranged so that adjacent samples represent distinct intervals of visual color perception. Based on physical samples, Munsell color space theoretically describes every possible color which can be described by three coordinates, corresponding to the above attributes. Within Munsell color space, a vertical axis, known as the value axis, represents color “value”. In other words, the value (lightness/darkness) of color is determined by the vertical position within color space. Color becomes lighter as the vertical position increases. The hue of color is determined by the angular position about the vertical value axis. The various hues are represented by vertical planes extending radially from the value axis. Moreover, every angular position about the axis, from 0 degree to 360 degree represents a different hue. The chroma (brightness/dullness) of color is determined by the radial distance from the value axis. Color is dull (gray) near the axis and becomes brighter, or more “chromatic” as the radial distance from the value axis increases. The Munsell system can also provide the hue circle from its color space, where the circle is divided into five equally spaced basic colors—yellow, red, purple, blue and green, in counterclockwise order—and five blends between them (yellow red, red purple, purple blue, blue green and green yellow). Each of these 10 color sections is divided into ten equal gradations, the central or “pure” hue in each category is located at division 5 (yellow is at 5Y, red at 5R, etc.). The hue spacing was determined through incremental perceptual comparisons between hues around the entire color circle, at different levels of chroma and lightness. Over small hue changes, equal distances along the circumference represent equal perceived differences between colors (thus, middle red and deep yellow are perceptually as different as green blue and red blue). This Munsell hue circle is usually said to represent visual complementary colors, positioned opposite each other on this color circle, although the incremental scaling method does not necessarily match visual complements on opposite sides of the color circle. In addition, the MUNSELL hue and chroma spacing turns out to be inconsistent when measured on the on the CIELAB a*b* plane due to the problem of hue dominance.

The mixing color wheels use a similar approach to the Munsell hue circle in establishing the circumference of the wheel by selecting two colors that can mix to a pure gray and placing these colors opposite each other on the circumference of the wheel. Once opposing color pairs have been determined, the spacing between neighbor colors is largely arbitrary, but can be determined by adjusting to equal apparent hue differences as much as the mixing relationships will allow. Also an effort is usually made to place the subtractive “primary” colors at the 12, 4 and 8 o'clock positions on the wheel. Even so, large gaps between hues or crowding of hues are unavoidable, because colors such as yellow have no effective mixing complements and because the neutralizing colors for blue, turquoise or yellow green paints are spread over a wide hue range.

A perceptually uniform color space which more closely approximates how humans perceive colors and differences in color to facilitate color specification tasks is known as the CIE system. In particular, standardized color notation systems for use in perceptually uniform color spaces have been developed by an international color standards group, Commission Internationale de l'Eclairage (the “CIE”). CIE color specification employs “tristimulus values” to specify colors and to establish device independents color spaces. In 1976, the CIE recommended the use of two approximately uniform color spaces, the CIE 1975 (L*u*v*) or the CIELUV color space, and the CIE 1976 (L*a*b*) or the CIELAB color space. The CIELUV space is often used to capture the color appearance of additive color mixtures, such as those on color display monitors, and as such is used as a standard color space by the television and video industries. CIELAB space is often used to capture the color appearance of subtractive color mixtures, and as such is a standard color descriptor for the paint and dye industries, and is the primary uniform color space used for printed color evaluation. An earlier developed system for subtractive color mixtures CIE color spaces are widely accepted because measured colors can readily be expressed in these CIE recommended coordinate systems by means of simple mathematical transformations.

In red, green and blue color space, higher value means more color. That is, full R+G+B equals white, zero R+G+B equals black, and equal amounts of R+G+B represents various shades of neutral. With hue (H), saturation (S) and luminance (L), color space is cylindrical polar. The axis of the cylinder defines the neutrals. The bottom of the axis represents black and the top of the axis represents white. All points on the axis have a luminance value, zero saturation, and an undefined hue. Saturation corresponds to the radial distance from the axis. The hue H represents the angle traveled around the axis, before travelling a distance S out from the axis to define a saturation. The angle of rotation around the axis is meaningless if the color in question is still at the axis; therefore, the neutrals (black, grey, white) along the axis have an undefined hue.

A CMYK color naming system has the form ‘ccmmyykk’, where

cc is the color's cyan component
mm is the color's magenta component
yy is the color's yellow component
kk is the color's black component.

The components are given as quoted hexadecimal numbers in the range 00 through FF. This scheme allows or up to 256 levels of each color component. For example, red is specified as ‘00FFFF00’, green as ‘FF00FF00’, process black (uses cyan, magenta, and yellow ink) as ‘FFFFFF00’, and pure black (uses only black ink) as ‘000000FF’. For CMYK color specifications, the quotes are required.

The HSV Color Space refers to Hue, saturation, and value (HSV) where hue is what is normally thought of as color, saturation is the amount of gray, white, or black that is mixed into the color, and the value component of the HSV space is a measure of its brightness. Zero saturation indicates no hue, just gray scale. The HSV color space is normalized where the color space is in the form of a hexcone where each of its cross sections is a hexagon. At the vertices of each cross section are the colors red, yellow, green, cyan, blue, and magenta. A color in HSV space is specified by stating a hue angle, the saturation level, and the value level. A hue angle of zero is red, and the hue angle increases in a counterclockwise direction. Complementary colors are 180 apart. The numbers associated with the HSV system for colors specified in terms of hue, saturation, and value (or brightness) components are of the form Vhhhssvv, where

V indicates that this is an HSV color specification
hhh is the color's hue component
ss is the color's saturation component
vv is the color's value or brightness component.

The components are given as hexadecimal numbers. The hue component has the range 000 through FFF. Valid values are 000 through 360 (168 base 16). If the value for the Hue is greater than 360 (168 base 16), the Hue will be calculated by using modular arithmetic with a modulus of 360 (168 base 16). Both the saturation and value (brightness) components are hexadecimal and have the range 00 through FF (when the saturation is zero, the color is a shade of gray determined by the value). Thus, they provide 256 levels for each component. For example, bright blue is specified as V0C8FFCC, light gray as Vxxx00BB, and White as Vxxx00FF, where xxx can be any hue. For white and black, the value component determines the intensity of gray level. Any combination of the color components is valid.

Also a color system and its notation is available from Imperial Chemical Industries PLC and The Glidden Company at Strongsville Ohio 44136 and is referred to as the Master Palette® system. The Master Palette system describes some 6134 colors in its system plus a page of Brights and a page of Grays with an identifying number for each color. In essence numerical notations for the Master Palette color system stem from a dissection of the rainbow. Perceiving the standard color wheel known to those skilled in the art in the shape of a solid ball, the neutrals from black to white are on the vertical axis running through the center of the ball. This axis influences the light reflectance “value”, or how light or dark the color appears. The hues ranging from red, orange, yellow, green, blue to violet (roughly around 700 nanometer {“nm”} to around 380 nm in wavelength) for the visible spectrum form the ball. The distance from the axis determines the intensity of the colors, or chroma within the ball. The deeper shades are closer to the center. These three values comprise the color notation. For example the notation “40YY/48/750” has the first (40YY) as the hue and color family. This color is 40 on a scale of 0-99 in the yellow/yellow family. The next two numbers (48) represent the light reflectance value on a scale of 0-99, where the higher the number, the lighter the color. The last three numbers (750) represent the chroma on a scale of 0-999: the higher the number, the more intense the color. Therefore for the original example notation, the color is a medium-deep intensity, medium-light yellow. Non-exclusive examples of suitable neutral colors include the following named colors further examples of these as defined in the color system of RGB and CMYK and HSV are included.

| Name | | RGB | | | CMYK | | | | HSV | |
|---|---|---|---|---|---|---|---|---|---|---|
| Beige | 245 | 245 | 220 | 0 | 0 | 26 | 10 | 60 | 10 | 96 |
| Bistre | 61 | 43 | 31 | 0 | 75 | 125 | 194 | 24 | 49 | 24 |
| Black | 0 | 0 | 0 | 0 | 0 | 0 | 255 | 0 | 0 | 0 |
| Brown | 150 | 75 | 0 | 0 | 128 | 255 | 105 | 30 | 100 | 59 |
| Buff | 240 | 220 | 130 | 0 | 21 | 117 | 15 | 49 | 46 | 94 |
| Cream | 255 | 253 | 208 | 0 | 2 | 47 | 0 | 57 | 18 | 100 |
| Gray | 128 | 128 | 128 | 0 | 0 | 0 | 128 | 0 | 0 | 50 |
| Khaki | 195 | 176 | 145 | 19 | 21 | 31 | 5 | 37 | 26 | 76 |
| Silver | 192 | 192 | 192 | 0 | 0 | 0 | 63 | 0 | 0 | 75 |
| Tan | 210 | 180 | 140 | 18 | 28 | 48 | 0 | 34 | 33 | 82 |
| White | 255 | 255 | 255 | 0 | 0 | 0 | 0 | 0 | 0 | 100 |

For the gray color any gray on the gray scale which includes any mixture of black and white to provide even up to 256 levels on the gray scale can be used. For example a gray scale to specify colors in terms of gray components by a hexadecimal number in the range 00 through FF can be used to show the lightness of the gray ranging GRAYFF as white to GRAY00 as black, and for example GRAY4C is a dark gray.

“Coordinating colors” means colors or attributes of color from one or more of the aforedescribed color systems or models or similar models where the colors are related one to another as complementary colors, temperature (warm or cool) colors, split-complementary colors, analogous colors diadic colors, triadic colors, or tetradic colors, or popular colors, or a combination of any two or more of these.

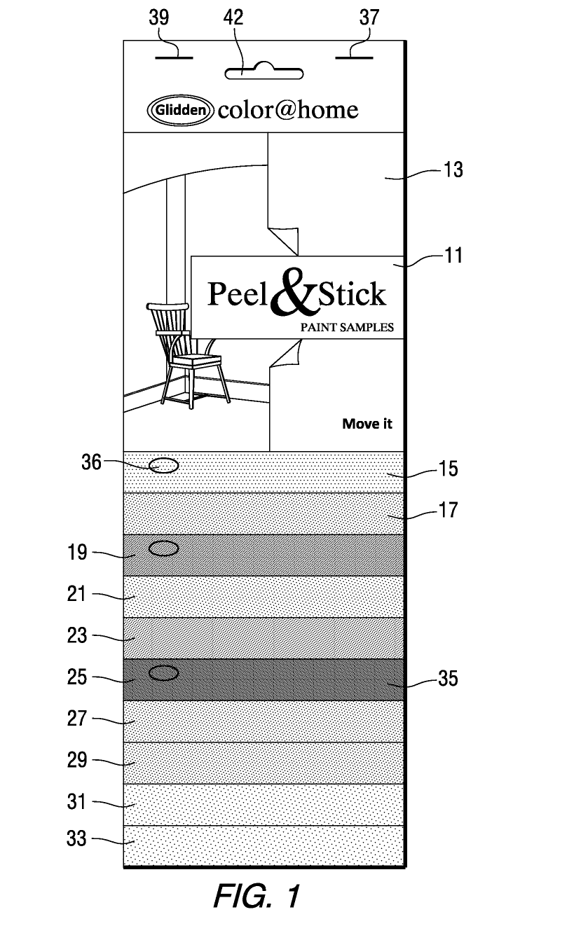

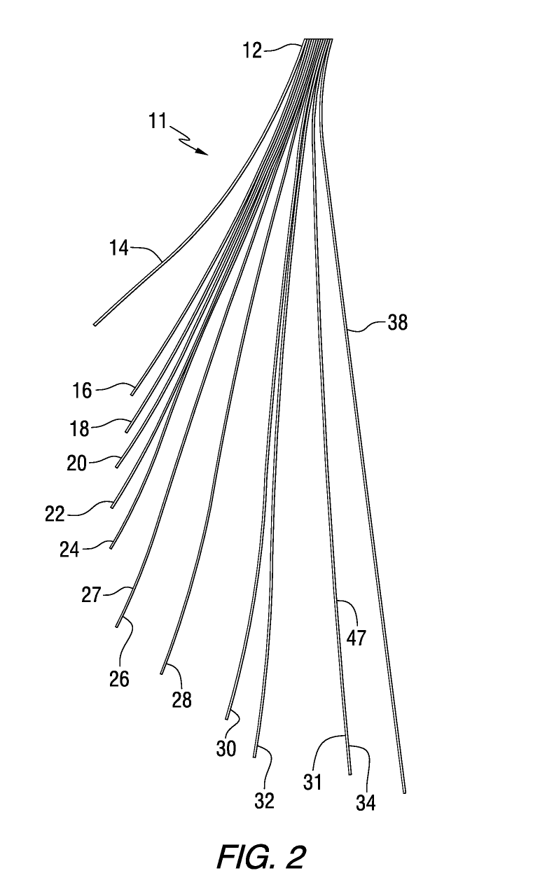

FIG. 1 is a top plan view of one embodiment of the color selection article 11 of the present disclosure. The article 11 here in a strip configuration has a plurality of color display sheets in overlapped stacked arrangement showing the color layers of each color ply of each color display sheets (shown in FIGS. 2, 3-5). The color layers (shown in FIGS. 2, 3-6) are visible from the cascading overlapping arrangement for the sheets for color plies 15, 17, 19, 21, 23, 25, 27, 29, 31 and 33. The configuration of the article is not limited to a strip but could be any geometric configuration that allows for accessible viewing of at least a portion of the color layers of article 11 and for the removal of the color layers for application to another surface. For example the article could be in the configuration of a typical fan deck bound for a movable relationship of the pages in a fan like manner. In this configuration each page would be a color display sheet with the color ply on the sheet. Also the configuration of article 11 could be circular or semi-circular or the like with the color plies having a triangular shape rather than a rectangular shape for the strip or fan deck configuration. Each color ply 15, 17, 19, 21, 23, 25, 27, 29, 31 and 33 optionally has one or more slits or perforated cuts like that of reference number 35 vertically through its thickness to the backing ply (shown in FIG. 2) at an exposed corner. Such slits 35 assist in the peeling removable of the repositionable color layer from the color display sheet. Additionally each color ply or layer optionally has an indicia of the color of the color layer for ease of identification. Such indicia can be the name of the color and/or a reference identification to a color system or model like those discussed above. The indicia at reference numeral 36 is a non-exclusive example of such an identification reference. Also article 11 optionally has at least attachment member 37 or two with 39 to attach a plurality of the color display sheets or color plies together to comprise the article. The attachment members can be any mechanical and/or chemical binding device as known to those skilled in the art. Non-exclusive examples include without limitation staples, clips, and/or adhesive binding. Also article 11 optionally has a hanging member reference number 41, to assist in the display of article 11 at the point of distribution or sale such as at a retail store. Hanging member 41 has an aperture 42 through article 11 so the article can hang on a hook or rod. However the hanging member could be a hook or tab attached to the article on the front cover 13 or back cover 38 (shown in FIG. 2) or bound or attached as an interleave between the color display sheets or attached to a color display sheet. Also the hanging member 41 could be an aperture of an extended back ply or back cover from the article or an aperture in the color plies themselves. FIG. 1 shows ten repositionable color plies three of which are neutral colors selected from shades of white and black. The number of repositionable color plies for the article should be at least two neutrals of black or white or shades of combinations of black and white. Also the article should have at least two color layers with different hues as coordinating colors. Optionally additional color layers can be in the article 11 which have coordinating colors of other attributes of color than hue that differ from the color layers of a particular hue in article 11. As shown in FIG. 1 there ten color plies of color display sheets in overlapping cascading arrangement to expose a portion of the color layers 15, 17, 19, 21, 23, 25, 27, 29, 31 of the color display sheets comprising article 11. Of course the number of color display sheets in an article can vary generally from 5 to 20 more suitably 7 to 15 and most suitably 8 to 12. In FIG. 1 the strip 11 has the plurality of overlapping color display sheets in an overlapping arrangement so that a portion of the color layer or at least a portion of the color layer of each color display sheet is exposed for viewing from the plan view perspective. With the overlapping arrangement the strip 11 view from its side has an appearance similar to a shingled roof. The plurality of color display sheets each have a different color layer in at least one aspect of color whether that aspect is hue, reflectant or chroma. However the difference in the aspect of color for the entire strip provides at least 3 neutral color layers on separate color display sheets and at least 2 coordinating color layer on separate color display sheets where the coordinating color layers have coordinating colors with at least each other.

The article shown in FIG. 1 is shown from a right side perspective in FIG. 2. In this perspective the color display sheets 16, 18, 20, 22, 24, 26, 28, 30, 32 and 34 are depicted in a slightly exaggerated fanned relationship. This is in comparison to their normal adjacent relationship of one on top of the other. Also shown to the left of color display sheet 16 is cover 14 which has optional image 13 as shown in FIG. 1 where article 11 is turned 90 degrees to show the front of the article. The orientation of article 11 in FIG. 2 is as viewed from the side of a hanging position from the narrow top of article 11 from a display hook or rod. Also shown in FIG. 2 is back cover 38. The back cover 38 can be separate from front cover 14 and bound together with the color display sheets or the back cover 38 can be a continuation of the front cover 14 as it wraps over the top of or around the side of article 11. Color display sheet 34 of FIG. 2 shows color ply 33 over backing ply 40. Backing ply 40 extends the entire length of the color display sheet 34 to serve as the support or backing for color ply 33 and to extend in length to the top 12 or article 11.

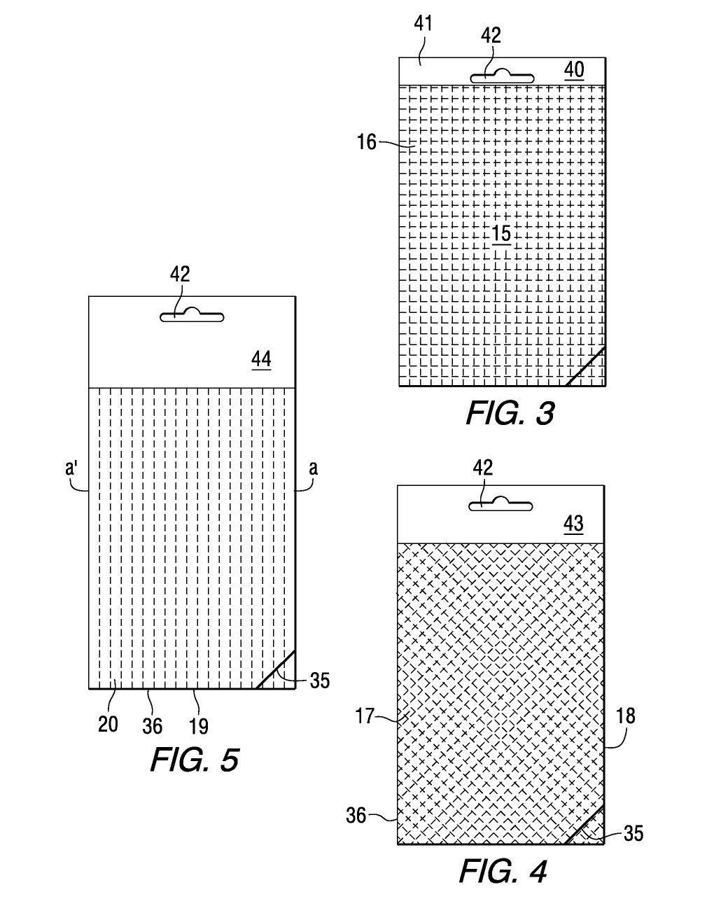

FIG. 3 is a plan view of the front of color display sheet 16 showing the front of color ply 15 having a neutral or coordinating color on its front surface. The extension of backing ply 40 extends beyond the length of the color ply 15. In this extension the hanging member 41 has a die cut so that this aperture 42 when aligned under cover 14 with a similar die cut aperture have matched apertures. Each color display sheet has a similar die cut aperture as does the front and back covers so that the article 11 has the aperture traversing through the thickness of the article. This provides a hanging member through which a rod or hook from a retail display stand can be placed. The aperture 42 of the various backing pays can have any shape such as circular, or elliptical arrangement shown for aperture 42. Of course in an alternative embodiment of the present invention each color layer in the strip could have a different length dimension to allow for an exposed section of the colored layer in the overlapping sheets in strip 11. In one aspect of the present invention or in one embodiment of the present invention each color display sheet in strip 11 has a collecting portion with a length that is longer than the collecting portion of the overlapping color display sheet. This allows the bottom portion of the color display sheet with the color layer exposed at the bottom of the color display sheet in the overlapping arrangement of the overlapping color display sheets of strip 11.

FIG. 4 is a plan view of the front of color display sheet 18 which in article 11 of FIG. 1 lies beneath color display sheet 16 of FIG. 3. Color display sheet 18 has similar features to that of color display sheet 16. The color layer of color ply 17 of sheet 18 can also have a neutral or coordinating color on its front upper surface. The extension of backing ply 43 extends beyond the length of the color ply 17. The extension of backing ply 42 has a longer length dimension than that of color display sheet 16 of FIG. 3. This is so the color plies for all of the color display sheets of article 11 more suitably have the same length and width dimensions. Therefore to obtain the cascading overlapping arrangement for the color plies of article 11 the backing plies need to have longer length dimensions one to the next beneath it in the stack of sheets to permit a longer length dimension for the underlying color display sheet. With the color ply positioned on the sheets at the end of the length dimension remote from the attachment members, this allows for a portion of each color ply to have its color layer exposed for view.

FIG. 5 is a plan view of the front of color display sheet 20 which in article 11 of FIG. 1 lies beneath color display sheet 18 of FIG. 4. Color display sheet 20 has similar features to that of color display sheet 16 and 18. The color layer of color ply 19 of sheet 20 can also have a neutral or coordinating color on its front upper surface as the color layer. The extension of backing ply 44 extends beyond the length of the color ply 19. The extension of backing ply 44 has a longer length dimension than that of color display sheets 16 of FIGS. 3 and 18 of FIG. 4. Again this is so the color plies for all of the color display sheets of article 11 more suitably have the same length and width dimensions, but have an exposed viewing portion in a cascading arrangement. For color display sheet 20 the aperture 42 is sized similarly as for all sheets of article 11 to provide a hanging member of the portion of the backing ply above the aperture. As with the other sheets the attachment member can be located through the sheet as indicated at 42. Also sheet 20 can like the other sheets have indicia of identification for the color of the color layer on the color ply. Also as in FIG. 1 slit 35 is indicated for ease of removal of the color ply from the backing ply of the sheet.

For all of the sheets of article 11 the color plies like those of 15, 17 and 19 of sheets 16, 18 and 20 could be bifurcated lengthwise to provide for two color plies on each color display sheet. Also the backing plies 40, 43, and 44 need not extend both under the color ply completely to a length longer than that of the color plies. For instance the backing ply could be more of a protective film that is peeled away from the color ply rather than the color ply being peeled from the backing ply. In this embodiment the color ply itself could have an aperture to provide a portion of the color ply as a hanging member. Also the color ply itself could have a perforated portion such as a centralized square, circle or rectangle for removal of that section of the thickness of the color ply to allow for viewing of a surface to which the repositionable color ply is adhered.

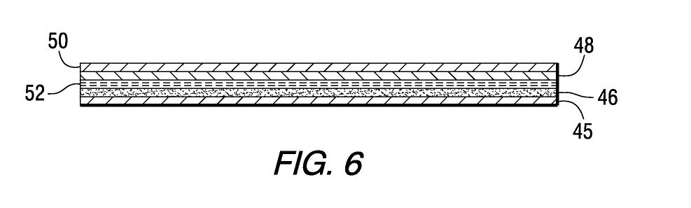

FIG. 6 shows a cross section of color display sheet 20 of FIG. 5 through lines a-a′. The backing ply 44 is comprised of at least backing ply substrate 45 and release material 46. The substrate 45 can be any flexible or rigid material that can support the release material, and color ply 19 for a color display sheet 20. In the alternative when the color ply 19 provides the support for the color display sheet 20 and others in the article the backing can be a material that protects the release material or be the back surface of the release liner itself. In the former arrangement the backing to provide adequate support can be polyester, polyethylene (PE) such as low density PE (LDPE) can be die cut to receive the color display sheet. The composition can be applied to at least a portion of at least one surface of suitable flexible or inflexible backing or sheet and cured to produce PSA-coated sheet materials. For example, it can be placed on a backing to form a tape. Or it can be applied to a sheet to form pressure sensitive sheets. For many purposes, it is preferred that the adhesive can be coated on both sides of a sheet. Those skilled in the art will recognize that novel adhesive can be applied to a variety of sheets and backings and can be simultaneously coated on both sides of the sheet or backing. Useful flexible backing materials include paper, plastic films such as poly(propylene), poly(ethylene), poly(vinyl chloride), poly(tetrafluoroethylene), polyester [e.g., poly(ethylene)terephthalate)], polyimide film such as DuPont's Kapton”, cellulose acetate and ethyl cellulose. Backings can also be of woven fabric formed of threads of synthetic or natural materials such as cotton, nylon, rayon, glass, or ceramic material, or they can be of nonwoven fabric such as air-laid webs of natural or synthetic fibers or blends of these. In addition, suitable backings can be formed of metal, metallized polymeric film or ceramic sheet material. PSA-coated sheet materials can take the form of any article conventionally known to be utilized with PSA compositions, such as labels, tapes, transfer tapes (comprising a film of the PSA borne on at least one release liner), signs, covers, marking indices, and the like. Primers can be utilized, but they are not always necessary. Tape and polyethylene-coated paper backings (which may be primed or unprimed paper or plastic) can also be utilized. The thickness of the backing can be any to either provide support for the color display sheet through the backing or as a protecting film. In one embodiment the thickness of a suitable thicknesses of each of the layers are as follows: the liner sheet—3.0 mil; the color layer—0.80 to 1.0 mil; the adhesive layer—0.60 to 0.75 mil; and the backing ply—8.3 or 8.5 to 9.0 mil. Alternatively, the liner sheet plus the color layer can have a 3.5 mil thickness.

The release material 46 can be a release composition on covering a substantial portion of the backing or a liner material or sheet itself to constitute the backing. A substantial portion is that which would allow a pressure sensitive adhesive of a color ply to be pulled away from the backing or liner without removing the PSA from the color ply. The release material as a composition can be is applied in liquid form, as a coating, but later solidifies into a film. The lamina-release agent may be composed of clear polyurethane, acrylic urethane, or any other substance which can be cured from liquid to solid and which performs substantially the same as the clear polyurethane, or the acrylic urethane, films. The use of a lamina-release agent has three purposes: it acts as the plastic laminate that remains on the back of the card; it acts as a dry release. The release agent may be comprised of a coating of clear varnish polyurethane which has a suitable thickness of 0.75 mils, but may range between 0.5 and 1 mil. Other substances which have been found satisfactory for use as the backing release agents are acrylic urethanes and other compounds which exhibit similar properties of being liquid when applied as a coating and curing into a solid film after drying. The backing layers may be a clear polyester film having a nominal thickness of 1 mil so that there is no need to apply an additional layer of patterned or dry edge adhesive to keep the card in position within the business form. Release liners are also well known and commercially available from a number of sources. Nonlimiting examples of release liners include silicone coated kraft paper, silicone coated polyethylene coated paper, silicone coated or non-coated polymeric materials such as polyethylene or polypropylene, as well as the aforementioned base materials coated with polymeric release agents such as silicone urea, fluorinated polymers, urethanes, and long chain alkyl acrylates, such as defined in U.S. Pat. Nos. 3,957,724; 4,567,073; 4,313,988; 3,997,702; 4,614,667; 5,2022,190; and 5,290,615; the disclosures of which are incorporated by reference herein and those liners commercially available as POLYSLIK brand liners from Rexam Release of Oakbrook, Ill., and EXHERE brand liners from P. H. Glatfelter Company of Spring Grove, Pa.

The PSA adhesive is one which allows for release of the color ply from a surface even without a release material in use within a less than 48 hours or 24 hours without leaving any unremovable adhesive residue and while leaving the PSA material on the color ply so that the color ply can be repositioned to another surface. Also the PSA needs to develop a an adherence to the repositioned surface upon the application of pressure so that the color ply does not fall from a vertical surface. Such characteristics are achieved with a PSA that is rubber based or acrylate ester based with polar monomers that also have microbeads or other physical members to prevent full contact of all of the PSA to the new repositioned surface. Also the PSA of acrylate esters with limited polar monomers can be used. Suitable adhesive is one has about 0.8 to about 3.0 oz. per inch bond strength using a 180 degree peel adhesion test after about a 24 hour dwell time and a minimum of about 250 grams of wet tack bond strength contact placement within about 30 seconds or less.

Over the release material is the releasable adhesive for the repositionable color ply. The color display sheets are also comprised of the backing and color layer. The releasable adhesive can be one that peels away with the color ply to releasably adhere the ply to other surfaces. The liner may be any release liner or transfer liner known to those skilled in the art that is capable of being structured as described above. The liner should also be capable of being placed in intimate contact with a pressure sensitive adhesive and subsequently removed without damaging the adhesive layer. Non-limiting examples of liners include materials from 3M Company of St. Paul, Minn., and Loparex of Willowbrook, Ill. The liner 100 is typically a polymer coated paper with a silicone release coating, a polyethylene coated polyethylene terepthalate (PET) film with a silicone release coating, or a cast polypropylene film with a silicone release coating. The liner 100 may also include structures (e.g., glass beads or non-adhesive protrusions) designed to enhance the positionability of the adhesive article such as those in products available from 3M Company under the trade designation CONTROLTAC (not shown in FIG. 1). The backings are suitably substantially continuous. The term substantially continuous as used in this application means a pattern of structures that creates a substantially uninterrupted network of channels in the adhesive layer that is applied to the release liner. The continuous structures are suitably substantially linear, and overlapping to some extent.

The adhesive layer may be coated and/or laminated on the backing layer. The properties of the pressure sensitive adhesive can change with time because of solvent loss, chemical reaction, oxidation, or other changes in the adhesive. The changes in properties usually result in an increase in adhesion, and often a change to more permanent adhesion.

The adhesive meets a peel test such as an adhesion, bond or peel tests that are used to evaluate joints, adhesives, coatings or adhesive tapes adherence, bond strength or peel strength. ASTM D-952 defines bond strength as the tensile stress required to rupture a bond formed by an adhesive between two metal blocks. Adhesion as the state in which two surfaces are held together by interfacial forces, which may consist of valence forces, interlocking action, or both. Adhesion is one of the most important properties of a coating (thin film, paint, plating or other systems). ASTM C-313 standards provide a method to measure of the adherence of porcelain enamel and ceramic coatings to sheet metal. According to ASTM D-903, the peel or stripping strength of an adhesive bond is the average load per unit width of bond line required to part bonded materials where the angle of separation is 180 degrees and separation rate is 6 in/min. ASTM D-1781 uses the applied torque required to separate an adhesive and adhered in the climbing drum peel test to provide measure of adhesion or peel resistance. Peel strength is commonly used to characterize adhesive tapes and coatings.

Peel Resistance

Torque required to separate an adhesive and adhered in the climbing drum peel test (ASTM D-1781). It is a measure of bond strength.

Peel Strength

Measure of the strength of an adhesive bond. It is the average load per unit width of bond line required to part bonded materials where the angle of separation is 180 degrees and separation rate is 6 in/min (ASTM D-903)

Tack is not simply a function of the material properties of the adhesive; it depends on the properties of the bonded surface, the contact pressure, the duration of contact, the rate of separation of the surface, the test environment, and the mechanical stiffness of the system. These factors provide complex combinations in simple tack tests. For example, reversed rankings can be produced by the loop and probe tack tests due to differences in contact times in the tests. Perhaps the most simple manifestation of this (and, unfortunately, a common problem in adhesive testing) occurs in the assessment of pressure-sensitive adhesives. PSAs develop a stronger bond over time, after the joint is made. Time is required for the viscous adhesive to wet the substrate surface and allow internal stresses to come to equilibrium. One should not test PSAs immediately after the joint is made unless this is the type of stress that the adhesive will experience in service. Adhesive must be quick adhering when positioned, releasable without leaving an adhesive residue preferably colorless and repositionable a number of times. Acrylate esters with polar monomers are suitable.

The repositionable adhesive layer is on one face of the color layer. In one embodiment of the present invention this face of the color layer in contact with the repositionable adhesive 45 is the opposite face of the color layer to be exposed for viewing of the color on a surface. The color layer can be produced as the color of a paint by using the actual paint or by using inks that approximate the color of the paint. Such color layers are produced in color chips by any methods known to those skilled in the art of producing color chips can be used.

Detachable color displays can range from pull out color cards with one or more apertures in the color display with or without at least one repositionable attachment member such as a repositionable adhesive. Such a repositionable adhesive can be one or more various types of adhesives, including without limitation the common repositionable pressure sensitive adhesives (RPSAs) that exhibit repositionable, removable characteristics. In this context, the term “repositionable” means that a thin card or film sheet covered by an effective amount of the adhesive in a conventional way can be adhered to and removed from a clean solid surface at least two times without substantially losing tack. Preferably, the sheet can be adhered to and removed from a clean solid surface at least four times, and more suitably, at least ten times, without substantially losing tack. RPSAs are well known in the art as evidenced by U.S. Pat. Nos. 5,045,569; 4,988,567; 4,994,322; 4,786,696; 4,166,152; 3,857,731; and 3,691,140, the disclosures of which are incorporated here by reference. Other useful adhesives include high peel adhesives that may permanently attach a film sheet. Examples of such adhesives include rubber resin and acrylic adhesives.

It will be apparent to those skilled in the art of adhesive and release materials that the aforementioned adhesive/release cooperating or coacting properties can be regulated and controlled by appropriate selection from among existing commercially-available materials and methods of application and thereby impart the temporary but readily peelable adhesiveness characteristics that are advantageous in the practice of this invention. Illustrative but not limiting examples of adhesives useful in the practice of this embodiment are Hycar 2110, B. F. Goodrich Co., Cleveland Ohio, which has low peel strength and therefore easily removed from the release-agent-containing playing surface; Amsco PSA 9201, Union Chemicals Division, Schaumburg, Ill. which is an acrylic copolymer emulsion formulated to not leave residual adhesive when peeled from the opposite surface; Amoco PSA 9204 an acrylic copolymer emulsion formulated to have excellent adhesion to release-coated surfaces; Covinax 266 and Covinax 300, acrylic polymer emulsions supplied by Franklin Chemical Industries, Columbus, Ohio, which also have low peel strength for easy removal from the board surface. Illustrative but not limiting examples of suitable release agents are Dow Corning 200 Fluid, Dow Corning 1101 Emulsion, Dow Corning HV490 Silicon Emulsion, all distributed by Dow Corning Corporation, Midland Mich.

The pressure sensitive adhesive may be selected from any of the known pressure sensitive adhesives, including acrylic, silicone, and rubber-resin pressure sensitive adhesives. By way of example, the pressure sensitive adhesive 50 may be an acrylic adhesive comprised of isooctyl acrylate (IOA) and acrylic acid (AA). Adhesives suitable for use with the present invention are described in U.S. Pat. No. 2,926,105 to Steinhauser et al., U.S. Pat. No. 3,331,729 to Danielson et al., U.S. Pat. No. 3,578,622 to Brown et al. and U.S. Pat. No. 4,835,217 and U.S. Pat. No. 4,699,842 to Jorgensen et al. Relatively weak adhesives, such as the acrylate-based microsphere adhesives disclosed in U.S. Pat. No. 3,691,140 to Silver, are also suitable for use as the adhesive 50 in accordance with the present invention.

The backing sheets of the carried adhesive articles also may be anything that functionally may carry an adhesive article. Suitably, the backing sheets of the carried adhesive articles are release sheets. Some examples of suitable materials for the release sheets include commercially available papers or films. Other examples of suitable materials for the release liners are commercially available silicone coated release liners, olefin release liners, and textured or embossed films. To obtain the releasable bonds between the adhesive articles and the backing sheets described above, the adhesive and the backing sheet may be selected such that the adhesive in the adhesive articles releasably adheres to the backing sheet without the need for any added release coatings. Alternatively, the backing sheets may be coated with a release coating. The release coating may be on the first major surface of the backing sheet, on the second major surface 24 of the backing sheet, or on both the first major surface 22 and second major surface 24 of the backing sheet. The release coatings on the first major surface 22 and second major surface 24 of the backing sheet may be the same or different. Suitable release coatings include coatings having silicone, urea silicones, alkyl acrylate, waxes, or fluorocarbon polymers. The adhesive article includes at least one layer of adhesive. Examples of suitable adhesives include pressure sensitive adhesives, heat activated adhesives, thermosetting adhesives and remoistenable adhesives. Particularly preferred adhesives include pressure sensitive adhesives that may be hot-melt adhesives, essentially solvent or water-free adhesives or solvent- or water-based dispersions or solutions. Specific pressure sensitive adhesives include acrylate-based pressure sensitive adhesives, styrene-isoprene block copolymers, acrylic ester-vinyl acetate copolymers, ethylene-vinyl acetate copolymers, plasticized vinyl acetate homopolymers and rubber-latex resin emulsion systems. In the practice of preferred embodiments of the invention, the adhesive composition comprises an acrylate-based pressure sensitive adhesive. Acrylate-based pressure sensitive adhesives useful in practicing the invention comprise polymers of one or more monomers of (meth)acrylic acids and optionally other copolymerizable monomers containing functional groups in addition to an ethylenically unsaturated group. The acrylate-based pressure sensitive adhesive may comprise conventional additives such as, for example, fillers, anti-oxidants, flame-retardants, pigments, tackifiers, plasticizers or polymer additives. By varying the nature and amount of the monomers and the nature and amount of the additives, the properties of the resulting adhesive can be changed as is known in the art.

Examples of acrylate-based pressure sensitive adhesives that are suitable in the practice of the invention are described in Satas, “Acrylic Adhesives,” Handbook of Pressure-Sensitive Adhesive Technology, 2nd ed. pp. 396-456 (D. Satas, ed.), Van Nostran Reinhold, N.Y. (1989). A particularly suitable acrylate based pressure sensitive adhesive includes copolymers of an acrylic or methacrylic acid and an alkyl acrylate or methacrylate wherein the alkyl group has at least 4 carbon atoms, typically 4 to 14 carbon atoms. Examples of such alkyl acrylates or methacrylates include n-butyl, n-pentyl, n-hexyl, cyclohexyl, isoheptyl, n-nonyl, n-decyl, isohexyl, isobornyl, 2-ethyloctyl, isooctyl, and 2-ethylhexyl acrylates and methacrylates. Preferred alkyl acrylates include isooctyl acrylate, 2-ethylhexyl acrylate, n-butylacrylate and cyclohexyl acrylate. A particularly preferred alkyl acrylate is isooctyl acrylate. Particularly preferred alkyl methacrylates include butyl methacrylate, cyclohexyl methacrylate, and isobornyl methacrylate.

The process and technology for preparing the color collection articles of the present disclosure can be that based on technology disclosed in U.S. Pat. Nos. 6,416,612B1, 4,457,718, U.S. Patent Application Publication 2003/0072907A1 to Lerner et al, Color Communications, Inc., all of which are hereby incorporated by reference.

### Examples

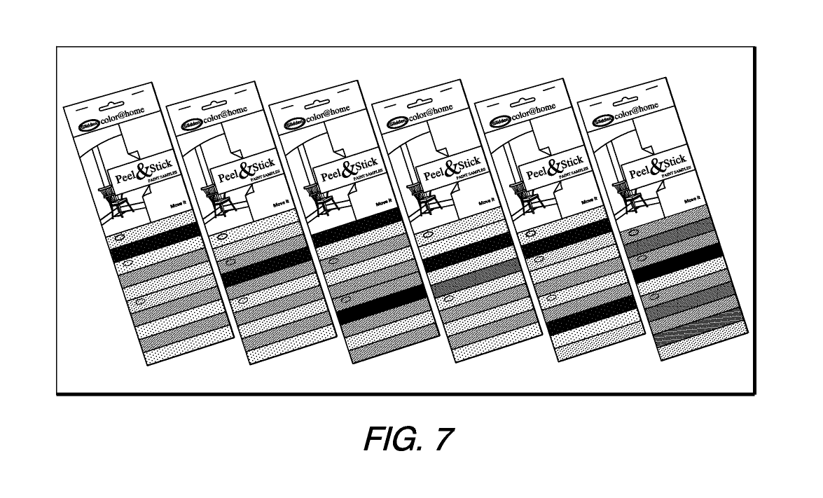

Examples of 6 color collections as in the kit of FIG. 7 having at least 3 neutral color layers and at least 2 coordinating color layers are shown in table 1 below. In table 1 the strip has 10 color display sheets and the master pallet number for each color display sheet is listed along with the color name and its characteristic whether neutral or a coordinating color. These collections of color layers assortment can be selected by any method known to those skilled in the art. These methods can include data gathering techniques from actual sale to customer over time for the most popular colors.

Example A below depicts the color display sheets as shown in FIG. 1. Example B shows the various color coordination with the plurality of strips of color display sheets as shown in FIG. 7. Each strip as numbered 54, 56, 58, 60, 62, and 64 of FIG. 7 has coordinated colors as separate collections to form the kit. The collections shown below relate to the numbered strips above as collections 1 thru 6.

| display sheet | Dimensions of color | Dimensions |
|---|---|---|
| in kit collection | Display sheet | of Base Layer |
| Upper most sheet 15 | 4 by 6 inch_weight | 4 by 6.5 inches_weight |
| sheet17 | | 4 by 7.25 inches |
| sheet19 | | 4 by 7.75 inches |
| sheet 21 | | 4 by 8 6/16 ⅜ |
| sheet 23 | | 4 by 9 |
| sheet 25 | | 4 by 9⅝ |
| sheet 27 | | 4 by 10¼ |
| sheet 29 | | 4 by 10⅞ |
| sheet 30 | | 4 by 11.5 |
| Lower most sheet 31 | | 4 by 12⅛ |
| Backing 32 | | 4 by 13 2/8 |

Exposed portion ⅝ inch/Cover 5 7/8/Hang hole ¼ inch diameter

| | Glidden | MASTER | | |
|---|---|---|---|---|
| | COLOR | PALETTE | | UPC |
| Collection 1 | TYPE | NUMBER | Color Name | 022367 . . . |
| 1 | | 11RR 65/165 | SWEET THING | 963163 |
| 2 | BL30 | 14RR 48/276 | VALENTINE PINK | |
| 3 | BL30 | 32RR 26/413 | TUTTI FRUTTI | |
| 4 | BL56 | 41RB 24/309 | PURPLE PASSION | |
| 5 | | 83YR 44/540 | OUTRAGEOUS ORANGE | |
| 6 | BL16 | 10GY 46/553 | PUCKER UP | |
| 7 | | 07GY 58/457 | | |
| 8 | NC32 | | MANDOLIN STRING | |
| 9 | NC32 | 60YR 63/022 | NOTABLE NEUTRAL | |
| 10 | NC29 | 70RB 83/004 | GALLERY WHITE | |
| | | MASTER | | |
| | | PALETTE | | |
| Collection 2 | Glidden | NUMBER | Color Name | 963170 |
| 1 | | 80YR 57/179 | | |
| 2 | NC6 | 70YR 35/216 | SONORA | |
| 3 | | 50YR 15/243 | CORDOVAN | |
| 4 | | 70GG 39/088 | BELIZE COAST | |
| 5 | | 70GG 54/070 | RESTORATION TEAL | |
| 6 | | 70GG 73/060 | | |
| 7 | NC37 | 20YY 31/106 | BRUSHWOOD | |
| 8 | NC37 | 30YY 51/098 | TOASTY GREY | |
| 9 | NC39 | 45YY 74/073 | OFF-WHITE | |
| 10 | CN9 | 61YY 89/040 | CRISP LINEN | |
| | | MASTER | | |
| | | PALETTE | | |
| Collection 3 | Glidden | NUMBER | Color Name | 963187 |
| 1 | | 40YY 65/263 | YELLOW BARN | |
| 2 | NC11 | 30YY 46/304 | WILD HONEY | |
| 3 | | 50RR 08/171 | STATELY BURGUNDY | |
| 4 | | 70BG 57/082 | EXALTED BLUE | |
| 5 | | 90BG 36/115 | ESSEX BLUE | |
| 6 | NC24 | 30BB 08/150 | KATANA | |
| 7 | NC54 | 00NN 37/000 | GRANITE GREY | |
| 8 | NC54 | 00NN 53/000 | VEIL | |
| 9 | NC54 | 00NN 72/000 | SNOWFIELD | |
| 10 | CN27 | 30BB 83/013 | MOONLIGHT SONATA | |
| | | MASTER | | |
| | | PALETTE | | |
| Collection 4 | Glidden | NUMBER | Color Name | 963194 |
| 1 | CN15 | 90YY 76/160 | CELADON GREEN | |
| 2 | NC15 | 70YY 61/182 | FENNEL | |
| 3 | NC15 | 70YY 49/206 | SAGE GREEN | |
| 4 | NC14 | 70YY 15/160 | LAURENTIAN | |
| 5 | BL2 | 13RR 06/179 | DEEP AUBERGINE | |
| 6 | | 70YR 11/279 | COPPER CANYON | |
| 7 | NC9 | 10YY 35/196 | BROWN BAG | |
| 8 | NC9 | 20YY 49/176 | BONJOUR BEIGE | |
| 9 | NC10 | 30YY 64/149 | OYSTER WHITE | |
| 10 | CN10 | 50YY 83/057 | SWISS COFFEE | |
| | | MASTER | | |
| | | PALETTE | | |
| Collection 5 | Glidden | NUMBER | Color Name | 963200 |
| 1 | | 30BB 63/124 | QUIET BLUE | |
| 2 | RC25 | 30BB 47/161 | ENCHANTMENT | |
| 3 | | 30BB 33/163 | BLUE PROVINCE | |
| 4 | | 40YY 61/381 | CHESHIRE YELLOW | |
| 5 | | 45YY 77/340 | SUNROOM YELLOW | |
| 6 | BL40 | 56YY 86/241 | LEMON ICE | |
| 7 | NC43 | 70YY 39/057 | SKIPPING STONE | |
| 8 | NC43 | 70YY 54/049 | EASTERN LIGHTHOUSE | |
| 9 | NC43 | 70YY 72/041 | RUFFLED FEATHERS | |
| 10 | NC55 | 30GY 88/014 | WHITE ON WHITE | |
| | | MASTER | | |
| | | PALETTE | | |
| Collection 6 | Glidden | NUMBER | Color Name | 963217 |
| 1 | BL34 | 52YR 37/501 | FULL BLOOM | |
| 2 | | 30YR 13/471 | CHILI SPICE | |
| 3 | BL4 | 00YR 08/409 | DRUM BEAT | |
| 4 | BL1 | 12RR 07/229 | PLUM ESCAPE | |
| 5 | NC31 | 50YR 06/081 | STEWART HOUSE BROWN | |
| 6 | NC22 | 30BG 08/143 | ARCTIC POOL | |
| 7 | | 30YY 42/083 | SEA GULL GREY | |
| 8 | NC38 | 30YY 58/082 | SAND WHITE | |
| 9 | NC38 | 30YY 71/073 | PRISM WHITE | |
| 10 | CN9 | 40YY 83/043 | ANTIQUE WHITE | |

What is claimed is:

1. A color selection article, comprising:
a plurality of color display sheets, each color display sheet being uniquely sized with respect to the other color display sheets, the plurality of color display sheets being arranged to form a cascading stack in which a portion each color display sheet is exposed to allow viewing of a color thereon and another portion of each color display sheet is covered, each color display sheet comprising:
a color ply comprising a color layer and an adhesive layer;
a backing ply comprising a first surface which cooperates with the adhesive layer of the color ply, at least a portion of the first surface comprising a release material; and
at least one attachment member to hold the plurality of color display sheets together.

2. The color selection article of claim 1 wherein the attachment member allows each color display sheet to be moved from an adjacent color display sheet in a direction normal to planes of the color display sheets while preventing the color display sheets from being moved with respect to each other in a direction parallel with the planes of the color display sheets.

3. The color selection article of claim 1 wherein at least one of the plurality of color display sheets comprises a plurality of color plies and a backing ply; and
wherein the plurality of color plies are disposed to display a respective color layer of each of the plurality of color plies.

4. The color selection article of claim 1 wherein the plurality of color display sheets comprise:
a plurality of color layers displaying an associated plurality of neutral colors.

5. The color selection article of claim 1 wherein the plurality of color display sheets comprise:
a plurality of color layers displaying an associated plurality of coordinating colors.

6. The color selection article of claim 1 further comprising a cover sheet.

7. The color selection article of claim 1 wherein each backing ply is longer than each respective color ply.

8. The color selection article of claim 1 wherein each of the color plies are dimensioned to prevent exposing any substantial portion of the first surface of each respective backing ply.

9. The color selection article of claim 1 wherein at least one color ply is dimensioned to expose a portion of the respective backing ply.

10. The color selection article of claim 1 wherein a majority of the color layers of the color display sheets vary from one another in at least two aspects of color selected from the group of: hue, reflectance value, and chroma in the Munsell color system.

11. The color selection article of claim 1 wherein there are 1 to 4 color layers for each backing sheet.

12. The color selection article of claim 1 further comprising at least one article display member.

13. The color selection article of claim of claim 1 wherein the at least one pressure sensitive adhesive material forms a layer on the opposing surface sufficient to hold the repositionable color ply to a vertical surface for at least 5 minutes.

14. The color selection article of claim 1 wherein the adhesive material is a pressure sensitive indirect adhesive, which releasably binds the color ply to the release material on the backing ply and has a bond strength using a 180 degree peel adhesion test in the range from about 0.8 to about 3.0 oz. per inch.

15. A method for making a color selection article, comprising:
forming a plurality of backing plies, each backing ply being uniquely sized with respect to the other backing plies;
forming a plurality of color plies, each color ply comprising a color layer and an adhesive layer;
removably attaching each color ply to a respective one of the backing plies to form a plurality of color display sheets;
arranging the plurality of color display sheets based on size to form a cascading overlapping stack of color display sheets in which a portion each color display sheet is exposed to allow viewing of the color thereon and another portion of each color display sheet is covered; and
attaching the plurality of color display sheets together.

16. The method for making a color selection article of claim 15 wherein the plurality of color display sheets are attached together by an attachment member that allows each color display sheet to be moved from an adjacent color display sheet in a direction normal to planes of the color display sheets while preventing the color display sheets from being moved with respect to each other in a direction parallel with the planes of the color display sheets.

17. The method for making a color selection article of claim 15 further comprising selecting the plurality of color plies such that the respective color layers display a plurality of coordinating colors.

18. The method for making a color selection article of claim 15 further comprising forming a cover sheet; and
wherein the attaching comprises attaching the cover sheet and the plurality of color display sheets together.

19. The method for making a color selection article of claim 15 further including selecting the plurality of color plies such that the respective color layers vary from one another in at least two aspects of color selected from the group of: hue, reflectance value, and chroma in the Munsell color system.

20. A surface color selection article, comprising:
a plurality of supports attached to each other at least one point; and
a plurality of detachable color display sheets, each detachable color display sheet is uniquely sized and formed over at least a respective support;
wherein the plurality of supports and the plurality of color display sheets are each arranged to form cascading stacks in which a portion each color display sheet is exposed to allow viewing of a color thereon and another portion of each color display sheet is covered,
wherein at least for a majority of the supports, each support has at least one detachable color ply,
wherein each support has:
i) a layer of release material over at least a portion of the support,
ii) a layer of pressure sensitive adhesive over at least a portion of the release material and,
iii) a color display layer over at least a portion of the pressure sensitive material,
wherein the color display layer and adhesive layer allow for repositioning of the color display layer to at least one other surface, and
wherein a majority of the color display layers in the article vary one from the other in at least two aspects of color selected from hue, reflectance value, and chroma in the Munsell color system.
